(19) United States
(12) Patent Application Publication
(10) Pub. No.: US 2025/0383859 A1
(43) Pub. Date: Dec. 18, 2025

(54) SYSTEMS AND METHODS FOR RESOURCE OPTIMIZED FIRMWARE UPDATES

(71) Applicant: Microsoft Technology Licensing, LLC, Redmond, WA (US)

(72) Inventors: Navneeth JAYARAJ, Bangalore (IN); Abhilash R. KASHYAP, Dublin, CA (US)

(73) Assignee: Microsoft Technology Licensing, LLC, Redmond, WA (US)

(21) Appl. No.: 18/744,358

(22) Filed: Jun. 14, 2024

(51) Int. Cl. G06F 8/65; G06F 8/71; G06F 11/14

(52) U.S. Cl. CPC G06F 8/65; G06F 8/71; G06F 11/1433

(57) ABSTRACT

Examples of the present disclosure describe devices, systems, and methods for optimizing firmware updates. In examples, a firmware update system receives, in a volatile storage, an update to a stored firmware in a non-volatile storage. The update and the stored firmware comprise multiple portions that can be updated. The firmware update system identifies differences between each portion of the update and a corresponding portion of the stored firmware. Upon identifying a difference in corresponding portions, the firmware update system computes a parity value using the portion of the update and the corresponding portion of the stored firmware. The firmware update system then associates the parity value with the updated portion and stores the parity value and the association. After the comparison is completed and parity values are computed for all portions of the update, the update is copied to non-volatile storage to replace the previously stored firmware.

### BACKGROUND

Traditionally, the firmware of devices implemented in computing systems is updated by writing the updated firmware to a staging location, and later, when the computing system is available, updating the firmware by copying the updated firmware from the staging location and writing the firmware to the firmware's final location for access by the devices implemented in computing systems. This firmware installation method of multiple write operations often results in prolonged updates and the computers in a computing system being busy for long periods. Also, an additional copy of the updated firmware is maintained on the final location. Maintaining storage for staging the firmware update and an additional copy makes the firmware maintenance expensive.

It is with respect to these and other general considerations that the aspects disclosed herein have been made. Also, although relatively specific problems may be described, it should be understood that the examples should not be limited to solving the specific problems identified in the background or elsewhere in this disclosure.

### SUMMARY

Examples of the present disclosure describe systems and methods for implementing devices for persisting containers across upgrades.

According to one or more embodiments of the present disclosure, a system to optimize firmware updates includes a processor and a memory coupled to the processor, consisting of computer-executable instructions executed by the firmware update system to perform operations. The operations include receiving, in a volatile storage, an update to stored firmware in a non-volatile storage. The update and the stored firmware are composed of multiple portions. The firmware update system begins the update process by comparing and identifying differences between each update portion and a corresponding portion of the stored firmware. Upon identifying a portion of the update different from a corresponding portion of the stored firmware, the firmware update system computes a parity value using that portion of the update and the corresponding portion of the stored firmware. Before finalizing the update, the firmware update system stores the computed parity value along with an association with the portion of the update. The firmware update system repeats the update process for all the portions of the update and then copies the update to the location of the stored firmware to replace the stored firmware.

Additionally, the system monitors the installed firmware for any errors in the execution of firmware and/or instability. The system addresses the errors and/or instability by recreating the older version of the firmware using the list of portions with differences and the parity values associated with those portions.

This summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Examples are described with reference to the following Figures.

FIG. 1 illustrates a block diagram of an example firmware update system for optimizing an update process of device firmware.

FIG. 2 illustrates various hardware and software services to optimize a firmware update.

FIG. 3 is a flow diagram of the interaction between components of an example firmware update system.

FIG. 4 illustrates a flow of firmware portions to update device firmware.

FIG. 5 depicts an example method for optimizing a firmware update.

FIG. 6 depicts an example method for optimized storage of updated firmware.

FIG. 7 depicts an example method for determining an optimized representation of updated firmware.

FIG. 8 is a block diagram illustrating an example of the physical components of a computing device for practicing aspects of the disclosure.

### DETAILED DESCRIPTION

Firmware refers to a software code or program embedded into devices (e.g., hardware devices) to facilitate the effective operation of the devices. Computing systems with devices whose firmware needs to be updated are handled by updating the firmware on the device or storage associated with devices needing firmware updates. Firmware updates occur in two steps: first, copying the firmware update to a staging area, and second, copying the staged firmware update to a final location accessible by a device executing the firmware. The firmware update system stages the firmware to allow the computing system with the device to complete running the workload before shutting down/going offline to install the firmware. The computing system may be inaccessible or busy during the installation of firmware.

Such methods require performing write operations twice for staging and installation. Each of these operations is time-consuming and keeps the computing system, hosting the device executing the firmware, busy. Additionally, the requirement of a staging area makes the firmware update system expensive by using twice the amount of storage. As the firmware is stored in non-volatile memory, such as NOR memory, the costs can be significant to store larger firmware.

Firmware is usually composed of multiple sub-portions (referred to as “ingredient firmware”) for different devices hosted by a computing system. In most cases, only an ingredient firmware is updated. Performing a write operation for all the firmware code, including updated portions and portions kept intact, wastes time, storage resources, and energy usage.

In light of the above-described challenges with firmware installation, there is a need to optimize both the storage and time required to install firmware updates. Disclosed herein is a system that skips firmware staging and maintains only information related to portion of updated firmware to regenerate the complete copy of the updated firmware upon identifying corruption in the updated firmware. In some scenarios, the disclosed system uses the information related to the updated firmware to revert to the previous version of the firmware upon identification of instability of a device utilizing the updated firmware or the entire system hosting the device. The disclosed system determines the firmware on the devices needing to be updated, writes the complete firmware only once, and stores information about updates as a backup copy.

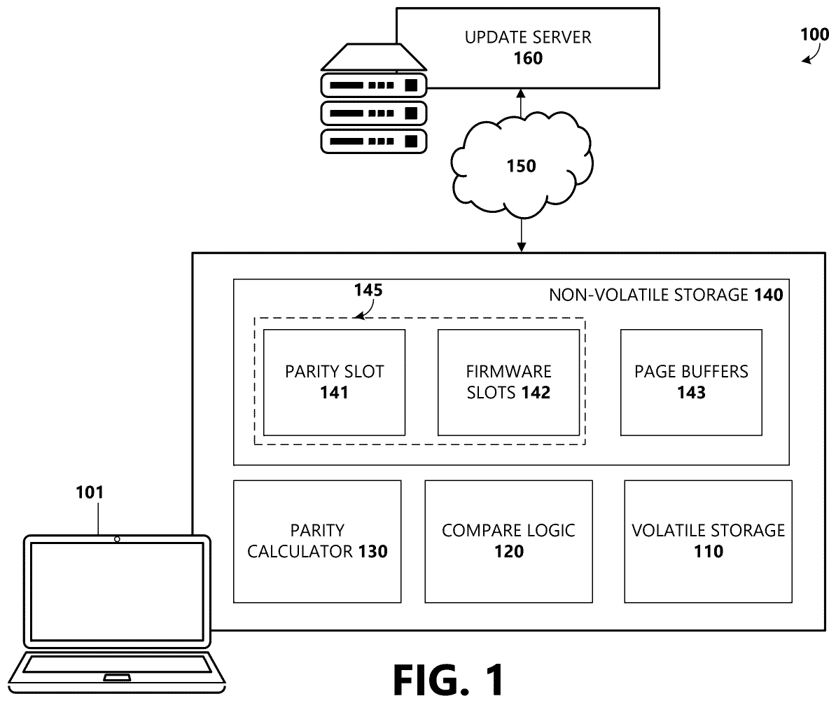

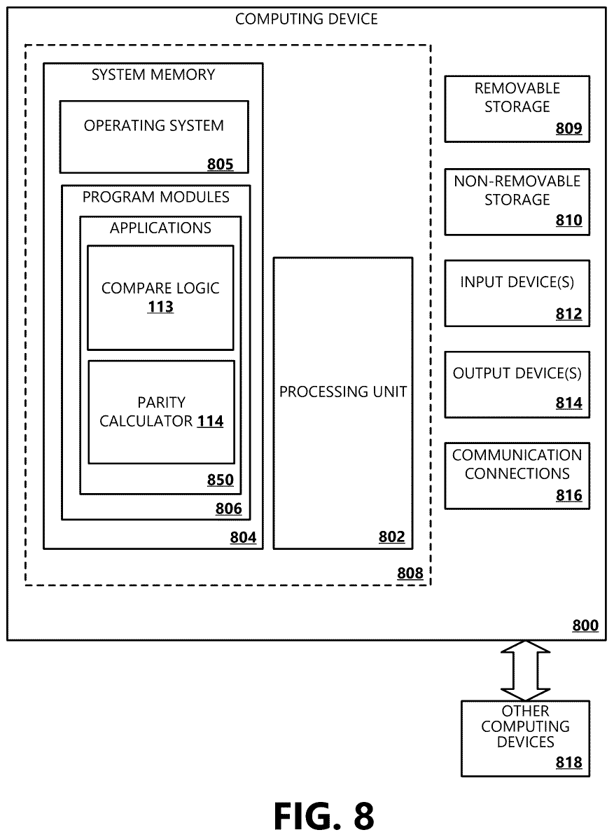

FIG. 1 illustrates a block diagram of an example firmware update system for optimizing firmware updates. The firmware update system 100, as depicted, is a combination of interdependent components that interact to form an integrated whole. Some components of system 100 are illustrative of software applications, systems, or modules that operate on a computing system or across a plurality of computing systems. Any suitable computer system(s) may be used, including web servers, application servers, network appliances, dedicated computer hardware devices, virtual server devices, personal computers, a system-on-a-chip (SOC), or any combination of these and/or other computing devices known in the art. In one example, components of systems disclosed herein are implemented on a single processing device. The processing device may provide an operating environment for software components to execute and use resources or facilities of system 100. An example of processing device(s) comprising such an operating environment is depicted in FIG. 8. In another example, the components of systems disclosed herein are distributed across multiple processing devices.

In FIG. 1, system 100 comprises computing device 101, network 150, and update server 160. The computing device 101, in turn, includes volatile storage 110, compare logic 120, parity calculator 130, and non-volatile storage 140. Non-volatile storage 140, in turn, consists of parity slot 141, firmware slots 142, and page buffers 143. Although system 100 is depicted as comprising a particular combination of computing devices and components, the scale and structure of devices and components described herein may vary and may include additional or fewer components than those described in FIG. 1. For instance, compare logic 120 and parity calculator 130 may be reside in non-volatile storage 140 and extracted for execution. Similarly, page buffers 143 may be reside outside non-volatile storage 140.

According to example implementations, computing device 101 may take a variety of forms, including desktop computers, laptops, tablets, smartphones, wearable devices, gaming devices/platforms, and virtualized reality devices/platforms (e.g., virtual reality (VR), augmented reality (AR), mixed reality (MR)). Computing device 101 includes a set of devices that use firmware to activate hardware components and provide certain functionality. For example, computing device 101 includes boot firmware, such as Unified Extensible Firmware Interface (UEFI) or basic input/output system (BIOS), to load an operating system to use the computing device 101. In another example, the firmware activates a graphics card to generate and display visual content. Computing device 101 manages the device's firmware by applying updates, detecting firmware corruption, and reverting an unstable version of the firmware to a previous version. Computing device 101 uses additional software and hardware components to manage firmware of devices in computing device 101. Firmware may be stored with the code of software and hardware components used to manage the firmware.

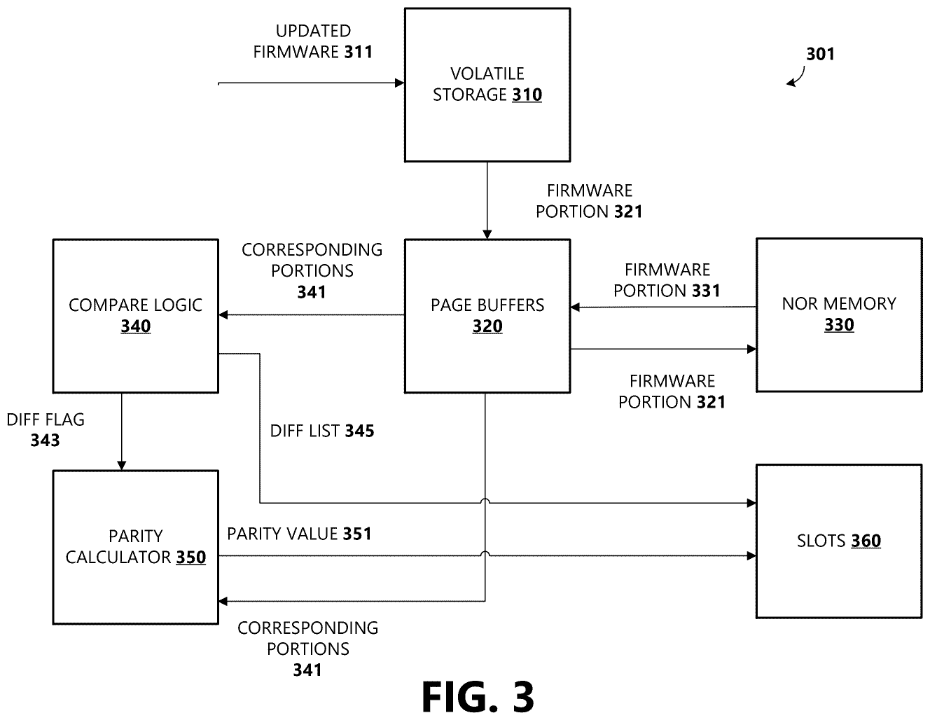

Storage in computing device 101 includes volatile storage 110 to temporarily host firmware updates and non-volatile storage 140 to persistently store the updated firmware as part of installation firmware updates. Volatile storage 110, such as random access memory (RAM), is a temporary storage for downloading the updated firmware and preparing for installation in non-volatile storage 140. Volatile storage 110 provides the updated firmware to compare logic 120 and parity calculator 130 to generate information about the updated firmware as part of the installation. The generated information is a shortened version of the updated firmware and is stored with the copy of the updated firmware. The shortened version is a backup copy of the firmware update and avoids additional storage required for storing a complete backup copy of the updated firmware. A detailed description of the generation of a shortened version of the updated firmware is presented in FIGS. 3, 4, and 6 descriptions below.

Compare logic 120 is a hardware component with code comparing the current and updated firmware in portions. For example, compare logic 120 is a microchip with the code for comparison in its storage, such as read-only memory (ROM). In some examples, compare logic 120 is code accessed and executed by a processor (not illustrated in FIG. 1) of computing device 101. Compare logic 120's code may reside in a partition of non-volatile storage 140 similar to partitions 145 of non-volatile storage 140. Compare logic 120 identifies the existence of a difference between the current and updated firmware. Upon identifying a difference, compare logic 120 calls parity calculator 130.

Compare logic 120 compares the current version of the firmware (hereinafter referred to as “current firmware”) used by a device of computing device 101 with the updated version of the firmware (hereinafter referred to as “updated firmware”) stored temporarily in volatile storage 110. Compare logic 120 compares the two versions of the firmware in portions by copying the portions to page buffers 143. In some examples, computing device 101 includes additional hardware, firmware, or software to copy the two firmware versions. A portion of firmware is a function or a set of statements of firmware code. In some examples, firmware is composed of ingredient firmware, each with different functionality, forming the firmware's portions. A firmware portion may be defined based on the storage capacity of page buffers 143 used to compare the firmware. For example, a firmware code storage size that is larger than the storage capacity of page buffers 143 is divided into portions of size equal to the storage capacity of page buffers 143.

Parity calculator 130 computes the parity value between the current firmware in non-volatile storage 140 and updated firmware in volatile storage 110. A parity value is a shortened version of the updated firmware, which includes information about the differences between the updated and current firmware. While compare logic 120 identifies the existence of differences between the current and updated firmware, parity calculator 130 determines what those differences are using parity values. Party calculator 130 computes the parity value upon compare logic 120 identifying a difference between the current and the updated firmware.

Parity calculator 130 is a hardware or software component with code to compute a parity value. For example, parity calculator 130 is a microchip with code for computing a parity value using corresponding firmware portions in the current and updated firmware. In some examples, parity calculator 130 is code executed by a processor of computing device 101. Parity calculator 130 code may reside in non-volatile storage 140 in a partition similar to partitions 145. Parity calculator 130 may use the same page buffers used by compare logic 120 or copy the current firmware portions and the updated firmware portions to a new set of page buffers of page buffers 143. Parity calculator 130 stores the parity value in parity slot 141. In some examples, parity calculator 130 may store the output of parity value computation in page buffers 143 for later copying to parity slot 141. Parity calculator 130 may also store the association between a portion of the updated firmware and parity value in parity slot 141.

Parity calculator 130 computes a parity value for each current and updated firmware portion. Corresponding current and updated firmware portions are copied to page buffers 143 to compute parity values. Parity calculator 130 is triggered by compare logic 120 when compare logic 120 identifies a difference between the current and updated firmware's corresponding portions. In some examples, a processor of computing device 101 executing compare logic 120's code calls parity calculator 130 when compare logic 120 code output indicates a difference between two compared corresponding firmware portions.

Non-volatile storage 140, such as flash storage, persistently stores the firmware used by devices of computing device 101 of system 100. As illustrated in FIG. 1, non-volatile storage includes parity slot 141, firmware slots 142, and page buffers 143 to persistently store the updated firmware and other information, about the updated firmware, such as a list identifying the updated firmware portions that are different from the current firmware's corresponding portions. Non-volatile storage 140 includes partitions 145 for parity slot 141 and firmware slots 142 to store firmware and other information about the updated firmware. Parity slot 141 and firmware slots 142 forming partitions 145 may be physical or logical partitions.

Non-volatile storage 140 may include different types of storage to store firmware and other related information. For example, parity slot 141 and firmware slots 142 are partitions of a NOR memory type storage, and page buffers 143 are another type of flash storage, such as a NAND memory. In some examples, partitions 145 are separate storages, each for storing different information associated with firmware, such as a list of the updated firmware portions with identified differences and the differences themselves. Non-volatile storage 140 may include additional hardware, such as compare logic 120 and parity calculator 130. In some examples, partitions 145 include additional partitions for storing code of compare logic 120 and parity calculator 130.

Parity slot 141 is a partition in non-volatile storage 140 that stores parity values computed by parity calculator 130 based on updated and current firmware. Firmware slots 142 are one or more partitions storing different versions of firmware. For example, firmware slots 142 store the updated firmware in one partition of firmware slots 142 and the previous version in another partition of firmware slots 142. The previous version of the firmware is used to revert the firmware to the previous version if the updated firmware causes the devices using the firmware to become unstable. In some examples, the previous version of the firmware is used along with the parity values in parity slot 141 to regenerate the updated firmware when the updated firmware is corrupted.

Update server 160 is a server providing information about the latest firmware versions for devices of computing device 101. In examples, computing device 101 queries (e.g., periodically or in response to a particular event) update server 160 for information about the latest version of the firmware. Update server 160 operates on a computing device located remotely from computing device 101. Computing device 101 communicates with update server 160 using one or a combination of networks 150 (e.g., a private area network (PAN), a local area network (LAN), and a wide area network (WAN)). In some examples, update server 160 is implemented in a cloud-based environment or server-based environment using one or more cloud resources, such as server devices (e.g., web servers, file servers, application servers, database servers), personal computers (PCs), virtual devices, and mobile devices. The hardware of the cloud resources may be distributed across disparate regions in different geographic locations.

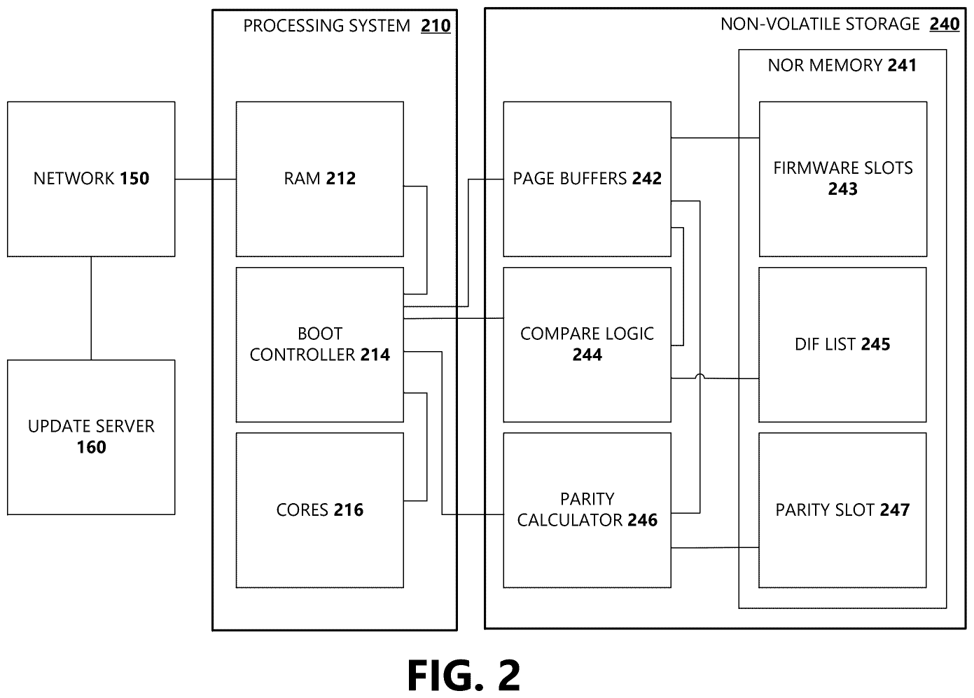

FIG. 2 illustrates various hardware and software services to optimize a firmware update. As illustrated in FIG. 2, processing system 210 is connected to update server 230 and non-volatile storage 240 to access and install updated firmware. Processing system 210 is connected to update server 230 through network 220 to receive updated firmware. Update server 230 may be a networked computing device accessible over network 220. In some examples, update server 230 is cloud-based. Update server 230 is functionally similar to update server 160 and can be used interchangeably. Network 220 is functionally similar to network 150 and can be used interchangeably. Processing system 210 and non-volatile storage 240 may form a computing device, for example, computing device 101 (as shown in FIG. 1).

Processing system 210 includes RAM 212 to access and temporarily store updated firmware during installation. Processing system 210 also includes boot controller 214 to access the firmware. For example, the firmware is a boot firmware used to boot processing system 210 and/or a computing device including processing system 210. Processing system 210 includes cores 216, such as central processing units (CPUs) and graphics processing units (GPUs), which execute methods for installing updated firmware. In some examples, cores 216 use the firmware when a user accesses certain functionality of processing system 210. For example, a user request to display an output causes a firmware to activate a GPU to generate the required graphical output. In some examples, processing system 210 is a system on a chip (SOC), with cores 216 being the processor cores. Cores 216 are the processors of processing system 210 that are run by devices using firmware. A processor of cores 216 connects with non-volatile storage 240 to install updated firmware by copying the update firmware to a persistent storage location in non-volatile storage 240.

RAM 212 is a volatile storage that hosts the updated firmware temporarily. For example, RAM 212 is functionally similar to volatile storage 110 (as shown in FIG. 1) and can be used interchangeably. RAM 212 may store and provide for execution by cores 216, the software to install updated firmware. For example, processing system 210 may retrieve firmware installation software, such as compare logic 244 and parity calculator 246, into RAM 212 for execution by cores 216.

Boot controller 214 manages firmware used by processing system 210 and boots processing system 210. The firmware may include firmware to instantiate cores 216 to execute software and/or boot processing system 210 by loading an operating system to execute on cores 216. For example, firmware may include BIOS or UEFI, which is used for booting processing system 210, or firmware on a graphics card, which is used to activate a GPU. Boot controller 214 includes a manager that updates the firmware. For example, boot controller 214 includes serial peripheral interface (SPI) logic or Quad-SPI (QSPI) logic to manage firmware by installing the updated firmware and reverting firmware when processing system 210 becomes unstable. SPI logic may exist on processing system 210 and non-volatile storage 240, forming a primary-subordinate setup to access and install firmware in non-volatile storage 240. Boot controller 214 works with RAM 212 and cores 216 to access and install the updated firmware by copying it to non-volatile storage 240. Boot controller 214 may request processing system 210 to download the updated firmware from update server 230. In some examples, update server 230 notifies of the availability of the updated firmware or transmits the updated firmware directly to the processing system 210 to store in RAM 212. During the boot-up of processing system 210, boot controller 214 accesses an installed firmware copied into page buffers 242 to load the firmware and perform the operations that are part of the firmware. For example, boot controller 214 accesses the current firmware by reading the contents of page buffers 242 to load the operating system on processing system 210 as part of booting processing system 210 or the computing device, including processing system 210.

Cores 216 are various types of processors, including CPU, GPU, neural processing unit (NPU), tensor processing unit (TPU), and application specific integrated circuit (ASIC). Cores 216 may be the cores of a processor or the processor itself. In some examples, Cores 216 may be a SOC. Cores 216 use firmware stored in non-volatile storage 240 and execute the firmware to access the operating system and other software, such as device drivers, needed to instantiate hardware that is part of processing system 210. Cores 216 may execute software to install updated firmware in non-volatile storage 240.

Non-volatile storage 240 is a storage location that persistently stores updated firmware as part of the installation of the updated firmware. Non-volatile storage is flash storage integrated as part of processing system 210 or additional hardware attached to the processing system 210, forming computing device 101 (as shown in FIG. 1). For example, non-volatile storage 240 is on a motherboard containing components of processing system 210. In another example, processing system 210 is the motherboard or SOC, including non-volatile storage 240. In some examples, non-volatile storage 240 coexists with cores 216. For example, non-volatile storage 240 may be a card attached to a motherboard through an interface such as a PCI interface. For example, non-volatile storage 240 is on a graphics card, including a GPU. In some examples, non-volatile storage 240 is hardware not directly linked to cores 216 and is attached separately.

As illustrated in FIG. 2, non-volatile storage 240 includes NOR memory 241 to store information about firmware. Non-volatile storage 240 also includes software, such as compare logic 244 and parity calculator 246, to generate information about the updated firmware and install the updated firmware. Non-volatile storage 240 also includes memory, such as page buffers 242, to temporarily store results of compare logic 244 and parity calculator 246 when generating information about the updated firmware. Page buffers 242 are functionally similar to page buffers 143 (as shown in FIG. 1) and can be used interchangeably.

NOR memory 241 is a type of solid-state memory used for fast retrieval of stored information. NOR memory 241 includes partitions to store firmware and information about the firmware in separate locations. As illustrated in FIG. 2, NOR memory 241 is partitioned into firmware slots 243, diff list 245, and parity slot 247. Firmware slots 243 are multiple logical partitions of NOR memory 241 to store different versions of the firmware used by processing system 210. Firmware slots 243 stores the current version of the firmware used by devices of a computing system, such as computing device 101 (as shown in FIG. 1). Additionally, firmware slots 243 may store the previous version, which has been updated, or the golden version which refers to the first version of the firmware installed on processing system 210.

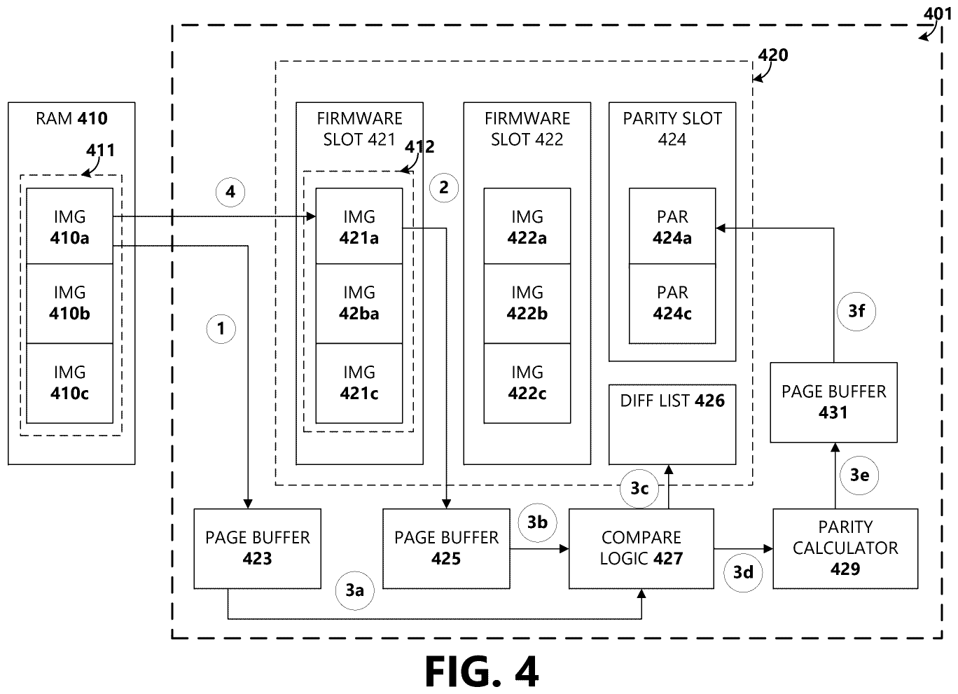

Firmware slots 243 store firmware in one or more portions. Such ingredient firmware may have a specific task, such as booting processing system 210, loading an operating system on cores 216, or initializing a graphics card. In some examples, a portion of a firmware may include a subset of firmware code, which can be evaluated for changes to install updated firmware. A detailed description of firmware portions is presented in the FIG. 4 description below. Firmware slots 243 is functionally similar to firmware slots 142 (as shown in FIG. 1) and can be used interchangeably.

NOR memory 241 includes information about the updated firmware in diff list 245 and parity slot 247. Diff list 245 stores a list identifying the updated firmware portions that are different from the current firmware as determined by compare logic 244. After installation of the updated firmware, the diff list 245 identifies the updated firmware portions that are different from the previous version. In examples, diff list 245 includes a ‘0’ for portions with no differences and a ‘1’ for previous firmware portions that re different from the updated firmware. In some examples, diff list 245 identifies updated firmware portions different from the golden version. Diff list 245 may include multiple lists identifying differences in the updated firmware of various devices that are part of processing system 210.

Parity slot 247 stores parity values computed using the updated and the current firmware. The parity values represent the changes to the firmware in the updated firmware. Parity slot 247 includes parity values only for those firmware portions that are different, as identified by the list in diff list 245. Parity slot 247 may include multiple sets of parity values for each firmware. Parity slot 247 is populated with parity values by parity calculator 246. Parity slot 247 is functionally similar to parity slot 141 (as shown in FIG. 1) and can be used interchangeably.

Compare logic 244 is hardware logic implemented in hardware, or includes software to compare the updated firmware with the current firmware stored in firmware slots 243. Compare logic 244 copies a portion of the updated firmware from RAM 212 to page buffers 242 and the corresponding portion of the current firmware from firmware slots 243. Compare logic 244 then compares the updated and current firmware's corresponding portions to identify if they are different. In some examples, boot controller 214 may access a portion of the updated firmware from RAM 212 and the corresponding portion of the current firmware from firmware slots 243 and copy the portions to page buffers 242.

Compare logic 244 may be hardware logic residing in non-volatile storage 240 or a software code stored in non-volatile storage 240. Boot controller 214 accesses compare logic 244 and executes it on cores 216 to determine differences between the updated firmware in RAM 212 and the current firmware stored in firmware slots 243. In some examples, compare logic 244 is a hardware component, such as an integrated circuit (e.g., a microprocessor or microcontroller) with programmable firmware, including instructions to compare two different firmware versions corresponding portions. Compare logic 244 may be a hardware component in non-volatile storage 240 packaged together with NOR memory 241 on the same circuit board. In some examples, compare logic 244 is part of processing system 210 or is an additional component on computing device 101 containing processing system 210 and non-volatile storage 240.

Parity calculator 246 is hardware logic implemented in hardware, or includes software to calculate parity values between the updated firmware portion in RAM 212 and the current firmware portion in firmware slots 243. Parity calculator 246 stores the resultant parity value in a page buffer of page buffers 242. The parity values in page buffers 242 are copied to parity slot 247 of NOR memory 241. Non-volatile storage 240 may include software to perform the copy operations. In some examples, boot controller 214 copies the parity value results from page buffers 242 to parity slot 247.

FIG. 3 is a flow diagram of the interaction between components of an example firmware update system. As illustrated in FIG. 3, firmware update system 301 updates the firmware used by computing device 101 (as shown in FIG. 1) by first accessing the updated firmware 311 to store in volatile storage 310. Firmware update system 301 may access the updated firmware 311 from update server 160 (as shown in FIG. 1). Volatile storage 310 is a RAM similar to volatile storage 110 (as shown in FIG. 1) of computing device 101. Volatile storage 310 has functionality similar to volatile storage 110 and can be used interchangeably. In some examples, volatile storage 310 is specialized dedicated storage hardware on the computing device that downloads updated firmware 311. Updated firmware 311 is downloaded over network 150 (as shown in FIG. 1; not illustrated in FIG. 3) and stored temporarily in volatile storage 310. Boot controller 214 (as shown in FIG. 2) may initiate the download of updated firmware 311 to volatile storage 310 and/or installation of updated firmware 311. Firmware portion 321 of the updated firmware 311 is transferred to page buffers 320 to begin installation. Page buffers 320 may receive the corresponding portion of current firmware stored in NOR memory 330 as firmware portion 331. Boot controller 214 or SPI logic in boot controller 214 may access firmware portions 321 and 331 to store in page buffers 320.

Firmware update system 301 may use firmware portion 321 in page buffers 320 to determine the corresponding firmware portion 331. Firmware update system 301 transmits corresponding portions 341, including firmware portions 321 and 331, to compare logic 340 to identify differences. In some examples, firmware update system 301 transmits firmware portion 321 to compare logic 340 to access the corresponding firmware portion 331 to identify the existence of any differences between them. In some examples, compare logic 340 accesses page buffers 320 to retrieve firmware portions 321 and 331. In some examples, compare logic 340 retrieves firmware portion 331 directly from NOR memory 330. The retrieval process of compare logic 340 may depend on the location of the compare logic 340. For example, compare logic 340 may access page buffers 320 for corresponding portions 341 when it is part of the same storage as NOR memory 330. Alternatively, compare logic 340 present on processing system 210 (as shown in FIG. 2) may directly retrieve firmware portions 321 and 331 from volatile storage 310 and NOR memory 330, respectively.

Compare logic 340 stores the result of the comparison in diff list 345. Compare logic 340 transmits updated diff list 345 to slots 360. Slots 360 may be partitions within NOR memory 330 or separate storage within a non-volatile storage (e.g., non-volatile storage 240 of FIG. 2), including NOR memory 330. Compare logic 340 transmits diff flag 343 to parity calculator 350 when firmware portion 321 and firmware portion 331 are different. In some examples, firmware update system 301 calls parity calculator 350 to generate parity value 351. For example, boot controller 214 calls parity calculator 350 to generate parity value 351 for firmware portion 321.

Parity calculator 350 receives corresponding portions 341 from page buffers 320. In some examples, compare logic 340 provides corresponding portions 341 instead of diff flag 343. In some examples, parity calculator 350 accesses firmware portions from different locations. For example, parity calculator 350 accesses firmware portion 321 from page buffers 320 or volatile storage 310 and firmware portion 331 from NOR memory 330. In some examples, parity calculator 350 stores the parity value 351 in page buffers 320. Firmware update system 301 copies the parity value 351 from page buffers 320 to slots 360. Slots 360 may include a dedicated partition to store parity values. For example, slots 360 include a dedicated partition, such as parity slot 247 (as shown in FIG. 2) to store parity value 351. The location to access firmware portions 321 and 331 and to store parity value 351 may differ based on the location of parity calculator 350. For example, when parity calculator 350 is part of non-volatile storage 240, including NOR memory 330, parity calculator 350 accesses firmware portion 331 directly or stores parity results in slots 360.

FIG. 4 illustrates a flow of firmware portions to update device firmware. As illustrated in FIG. 4, firmware installation begins by processing the updated firmware portions. Upon completing the processing of all portions (IMG 410a-c) of the firmware, each firmware portion is copied from RAM 410 to firmware slot 421 as IMG 421a-c. In another example, the firmware portion is copied immediately after being processed by compare logic 427 and parity calculator 429. RAM 410 is functionally similar to RAM 212 (as shown in FIG. 2) and can be used interchangeably.

The firmware update system (e.g., firmware update system 301 of FIG. 3) begins processing the updated firmware 411 for installation at step 1. At step 1, the updated firmware portion IMG 410a of updated firmware 411 from RAM 410 is copied to page buffer 423 of non-volatile storage 401. The portion of updated firmware 411 is pre-determined as chunks of size matching the storage capacity of page buffer 423. In some examples, the size of portions is based on the connection bandwidth between RAM 410 and non-volatile storage 401 (e.g., page buffer 423). Non-volatile storage 401 is functionally similar to non-volatile storage 240 (as shown in FIG. 2) and can be used interchangeably.

Upon copying the updated firmware portion IMG 410a, the firmware update system identifies the corresponding portion of current firmware 412 and processes the current firmware 412's portions at step 2. At step 2, the current firmware portion IMG 421a is copied from firmware slot 421 of NOR memory 420 to page buffer 425. Firmware slot 421 is a partition of NOR memory 420 that stores current firmware 412. Firmware slot 421 and NOR memory 420 are functionally similar to firmware slots 243 (as shown in FIG. 2) and NOR memory 241 (as shown in FIG. 2) and can be used interchangeably. On populating page buffers 423 and 425, the firmware update system begins processing the portions to generate information associated with updated firmware 411 in multiple sub-steps of step 3.

At step 3, which includes sub-steps 3a-e, firmware portions from RAM 410 and firmware slot 421 are accessed by compare logic 427 and parity calculator 429. In particular, in sub-steps 3a and 3b, firmware portions IMG 410a and IMG 421a in page buffers 423 and 425, respectively, are accessed by compare logic 427 to determine differences between the firmware portions. Compare logic 427, then stores a difference indicator (e.g., a ‘0’ or ‘1’) that is based on whether there is a difference between the firmware portions IMG 410a and IMG 421a in page buffers 423 and 425. At sub-step 3c, the comparison result is stored by compare logic 427 in diff list 426. Diff list 426 is functionally similar to diff list 245 (as shown in FIG. 2) and can be used interchangeably.

At sub-step 3d, if there is any difference in the code of the firmware in the firmware portions on page buffers 423 and 425, then compare logic 427 calls parity calculator 429 to generate a parity value (e.g., parity value 351 of FIG. 3). At sub-step 3e, parity calculator 429 stores the parity value in page buffer 431. At sub-step 3f, the parity value in page buffer 431 is stored in parity slot 424 as PAR 424a corresponding to updated firmware 411's portion IMG 410a. Parity value PAR 424a is associated with the firmware portion IMG 410a. In some examples, the parity value PAR 424a is mapped to the final location of firmware portion IMG 410a (e.g., IMG 421a of firmware slot 421) without referring to the contents of the firmware portion in the final location. Page buffers 423, 425, and 431 are functionally similar to page buffers 242 (as shown in FIG. 2) and can be used interchangeably to store a portion of firmware.

Upon successfully determining diff list entries and parity values, the firmware portions 410a-c of updated firmware 411 in RAM 410 are copied to the respective locations of corresponding portions 421a-c of the current firmware 412 in firmware slot 421. Upon successfully copying the updated firmware as portions to firmware slot 421, the portions are copied to firmware slot 422 to make a backup copy. In some examples, firmware slot 422 maintains portions IMG 422a-c that are the previous firmware portions. The previous firmware portions are used to revert the updated firmware 411 to a previous firmware, if the updated firmware 411 copied to firmware slot 421 causes stability issues for the computing device (e.g., computing device 101 of FIG. 1).

Having described a system that may be used by the aspects disclosed herein, this disclosure will now describe methods that may be performed by various aspects of the disclosure. In aspects, methods 500-700 may be executed by a system, such as system 100 of FIG. 1. However, methods 500-700 are not limited to such examples.

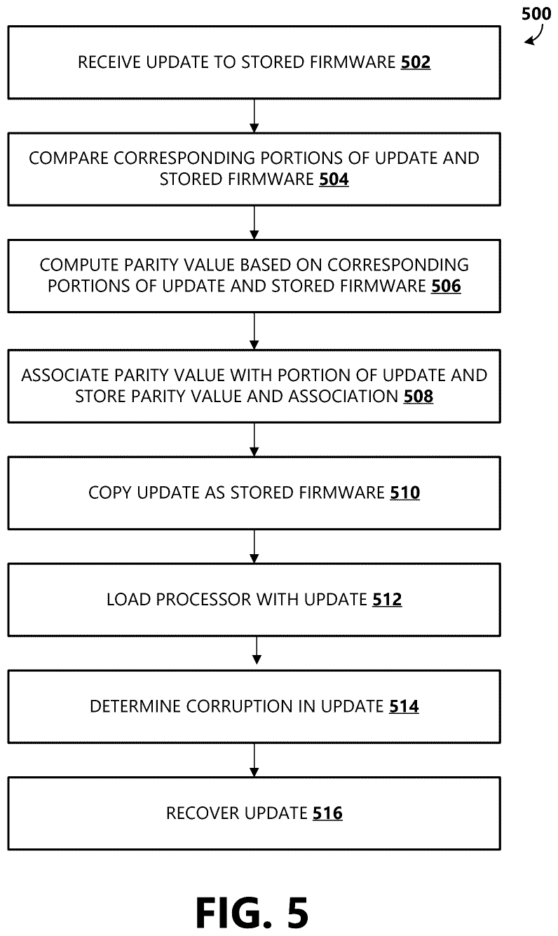

FIG. 5 depicts an example method for optimizing a firmware update. At operation 502, the firmware update system (e.g., system 100 of FIG. 1) receives the updated firmware (e.g., updated firmware 311 of FIG. 3) for the stored firmware (e.g., current firmware 412 of FIG. 4). The update is a complete copy of the updated firmware. In some examples, the update includes only the updated firmware portions and the identification of corresponding firmware portions in the stored firmware. The updated firmware is received at volatile storage (e.g., volatile storage 110 of FIG. 1). The updated firmware may be received over a network (e.g., network 150 of FIG. 1) from an update server (e.g., update server 160 of FIG. 1).

At operation 504, the corresponding portions (e.g., corresponding portions 341 of FIG. 3) of the updated and stored firmware are compared. Firmware update system 100 uses compare logic (e.g., compare logic 120 of FIG. 1) to compare corresponding firmware portions. The firmware update system copies the corresponding portions to page buffers (e.g., page buffers 242 of FIG. 2) before comparing the corresponding firmware portions.

At operation 506, a parity value (e.g., parity value 351) is computed using corresponding updated and stored firmware portions. The firmware update system uses a parity calculator (e.g., parity calculator 130 of FIG. 1) to compute the parity values.

At operation 508, parity values are associated with a portion of the updated firmware. The association includes the final storage location of the updated firmware portion. In some examples, the association includes the identifier of the updated firmware portion. The parity values and the associations are then stored in a non-volatile storage (e.g., non-volatile storage 140 of FIG. 1), where the updated firmware will be stored as part of the installation process.

At operation 510, the updated firmware is copied to the location (e.g., firmware slot 421 of FIG. 4) of the stored firmware. The firmware update system copies each portion from the initial temporary location, i.e., volatile storage, to the location of the corresponding portion of the stored firmware in a firmware slot of the non-volatile storage.

At operation 512, a processor (e.g., cores 216 of FIG. 2) is loaded with the updated firmware to execute the updated firmware. The processor is loaded with the updated firmware by restarting the computing device (e.g., computing device 101) hosting the processor.

At operation 514, the updated firmware is reviewed for corruption by checking for stability issues. The stability issues may be manifested in the form of errors when executing the firmware by the processors of a computing device. In some examples, stability issues are manifested in the form of decreased performance throughput of the computing device and the hardware components of the computing device.

At operation 516, the updated firmware is recovered by revising the updated firmware received at operation 502. The firmware is revised by combining stored parity values with the previous firmware version, i.e., the stored firmware. For example, an “exclusive or” (XOR) operation is performed between the parity values, such as PAR 424a (as shown in FIG. 4) with the associated portion IMG 421a (as shown in FIG. 4) in the previous version of the firmware to regenerate the portion IMG 410a (as shown in FIG. 4) of the updated firmware. The regenerated portion replaces the existing portion of the firmware, which was deemed corrupt in operation 514. In some examples, the computing device hosting the processor is reverted to use the previous firmware version.

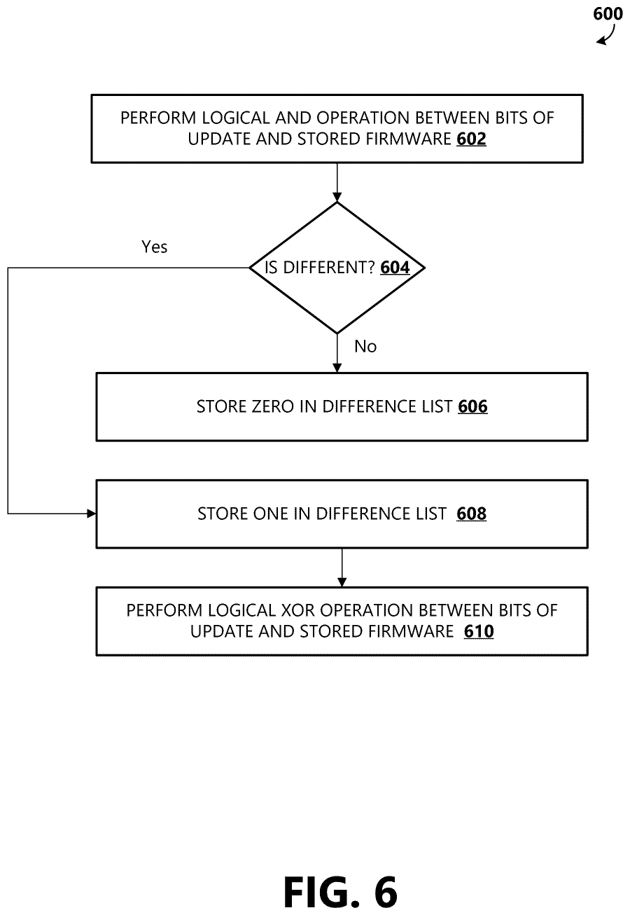

FIG. 6 depicts an example method for optimized storage of updated firmware. At operation 602, a logical XOR operation is performed between the updated (e.g., updated firmware 411 of FIG. 4) and stored firmware (e.g., current firmware 412 of FIG. 4) by the compare logic (e.g., compare logic 120 of FIG. 1) component of the computing device (e.g., computing device 101 of FIG. 1). The compare logic component may access the updated and stored firmware from page buffers (e.g., page buffers 143 of FIG. 1). The logical XOR operation results in a Boolean value (e.g., “TRUE” or “1”) if the updated and stored firmware are the same. For example, the updated and stored firmware is serialized, and a logical XOR operation is performed on the serialized outputs. The compare logic performs the logical XOR operation on the stored and updated firmware portions individually. The firmware update system (e.g., system 301 of FIG. 3) stores the updated and stored firmware's corresponding portions in page buffers accessed by the compare logic to perform a logical XOR operation.

Alternatively, the compare logic first performs a bitwise XOR operation between the updated and stored firmware bits to determine whether any bits differ, resulting in a “1” value. After completing the bitwise XOR operation, an OR operation is performed against all the generated bit values. When all the updated and stored firmware bits are the same, the bitwise XOR operation generates all bits with “0” value. The OR operation combines the generated bits that are “0” results into a “0” value. Alternatively, if even a single bit of the updated firmware differs from the stored firmware, the XOR operation generates at least one bit with “1” value, and the OR operation combines the bits results into a “1” value.

At operation 604, the compare logic of a firmware update system checks whether the updated firmware and the stored firmware differ by reviewing the result of logical XOR operation at operation 602. The compare logic checks whether the result of the operation is “0” (indicating there is no difference) or “1” (indicating there is a difference). If there is a difference, method 600 proceeds to operation 608. Otherwise, if there is no difference, method 600 proceeds to operation 606.

At operation 606, the compare logic stores the “0” value in the difference list (e.g., diff list of FIG. 2). In some examples, the compare logic stores the “0” value in a page buffer, and the firmware update system copies the “0” value to the difference list at a later time.

At operation 608, the compare logic stores the “1” in the difference list (e.g., diff list of FIG. 2). In some examples, the compare logic stores the “1” value in a page buffer, and the firmware update system copies the “1” value to the difference list at a later time.

At operation 610, a bitwise XOR operation is performed between the updated and stored firmware bits. The bitwise XOR operation is performed as part of parity value (e.g., parity values 351 of FIG. 3) generation by the parity calculator (e.g., parity calculator 130 of FIG. 1). The parity calculator performs the bitwise XOR operation on the updated and stored firmware's corresponding portions that are different. The parity calculator identifies the different portions based on the difference list entries stored at operations 606 and 608. The parity values are only calculated when the different list entry associated with the updated firmware portion is “1.”

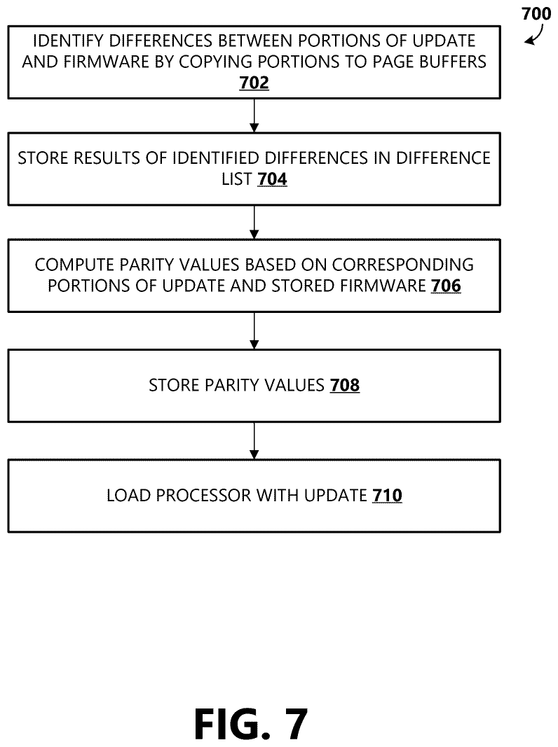

FIG. 7 depicts an example method for determining an optimized representation of updated firmware. At operation 702, differences between the updated (e.g., updated firmware 411 of FIG. 4) and stored firmware (e.g., current firmware 412 of FIG. 4) are identified by identifying the updated firmware's portions (e.g., IMG 411a of FIG. 4) that are different from those of the stored firmware (e.g., IMG 421a). The compare logic (e.g., compare logic 427 of FIG. 4) compares the firmware portions to identify if they are different. The updated and stored firmware portions are copied to page buffers (e.g., page buffers 423 and 425 of FIG. 4) for the compare logic to identify the updated firmware's portions that differ from the stored firmware's corresponding portions.

At operation 704, the results of identified differences in operation 702 are stored in a difference list (e.g., diff list 426 of FIG. 4). In examples, the compare logic stores “0” for the corresponding portions that are the same and “1” for the corresponding portions that are different as difference list entries.

At operation 706, parity values (e.g., parity values 351) are computed based on the updated and stored firmware's corresponding portions. The parity calculator (e.g., parity calculator 130 of FIG. 1) is used to compute the parity values.

At operation 708, the parity values are stored in a non-volatile storage (e.g., non-volatile storage 401 of FIG. 4) with the firmware. In particular, the parity values may be stored in a NOR memory (e.g., NOR memory 420 of FIG. 4) partition (e.g., parity slot 424 of FIG. 4).

At operation 710, a processor (e.g., cores 216 of FIG. 2) is loaded with the updated firmware to execute the updated firmware. In some examples, the computing device (e.g., computing device 101 of FIG. 1) hosting the processor needs to be restarted to load the updated firmware.

FIG. 8 is a block diagram illustrating the physical components (e.g., hardware) of a computing device 800 with which examples of the present disclosure may be practiced. The computing device components described below may be suitable for one or more of the components of the firmware update systems described above. In a basic configuration, the computing device 800 includes at least one processing unit 802 and a system memory 804. Depending on the configuration and type of computing device 800, the firmware update system memory 804 may comprise volatile storage (e.g., random access memory), non-volatile storage (e.g., read-only memory), flash memory, or any combination of such memories. The firmware update system memory 804 may include an operating system 805 and one or more program modules 806 suitable for running software applications 850 (e.g., compare logic 113 and parity calculator 114 of FIG. 1) and other applications.

The operating system 805 may be suitable for controlling the operation of the computing device 800. Furthermore, aspects of the disclosure may be practiced in conjunction with a graphics library, other operating systems, or any other application program and is not limited to any particular application or system. This basic configuration is illustrated in FIG. 8 by those components within a dashed line 808. The computing device 800 may have additional features or functionality. For example, the computing device 800 may also include additional data storage devices (removable and/or non-removable) such as, for example, magnetic disks, optical disks, or tape. Such additional storage is illustrated in FIG. 8 by a removable storage device 809 and a non-removable storage device 810.

As stated above, a number of program modules and data files may be stored in the firmware update system memory 804. While executing on the processing unit 802, the program modules 806 may perform processes including one or more of the stages of methods 500, 600, and 700 illustrated in FIGS. 5-7. Other program modules that may be used in accordance with examples of the present disclosure and may include applications such as search engines and database applications, etc.

Furthermore, examples of the disclosure may be practiced in an electrical circuit comprising discrete electronic elements, packaged or integrated electronic chips containing logic gates, a circuit utilizing a microprocessor, or on a single chip containing electronic elements or microprocessors. For example, examples of the disclosure may be practiced via a system-on-a-chip (SOC) where each or many of the components illustrated in FIG. 8 may be integrated onto a single integrated circuit. Such an SOC device may include one or more processing units, graphics units, communications units, system virtualization units, and various application functionality, all of which are integrated (or “burned”) onto the chip substrate as a single integrated circuit. When operating via an SOC, the functionality described herein with respect to detecting an unstable resource may be operated via application-specific logic integrated with other components of the computing device 800 on the single integrated circuit (chip). Examples of the present disclosure may also be practiced using other technologies capable of performing logical operations such as, for example, AND, OR, and NOT, including mechanical, optical, fluidic, and quantum technologies.

The computing device 800 may also have one or more input device(s) 812 such as a keyboard, a mouse, a pen, a sound input device, a touch input device, a camera, etc. The output device(s) 814 such as a display, speakers, a printer, etc. may also be included. The aforementioned devices are examples and others may be used. The computing device 800 may include one or more communication connections 816 allowing communications with other computing devices 818. Examples of suitable communication connections 816 include radio frequency (RF) transmitter, receiver, and/or transceiver circuitry; universal serial bus (USB), parallel, and/or serial ports.

The term computer readable media as used herein includes volatile and nonvolatile, removable and non-removable media implemented in any method or technology for storage of information, such as computer readable instructions, data structures, or program modules. The firmware update system memory 804, the removable storage device 809, and the non-removable storage device 810 are all computer readable media examples (e.g., memory storage.) Computer readable media include random access memory (RAM), ROM, electrically erasable programmable ROM (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 800. Any such computer readable media may be part of the computing device 800. Computer readable media does not include a carrier wave or other propagated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, communication media may include wired media such as a wired network or direct-wired connection, and wireless media such as acoustic, RF, infrared, and other wireless media.

In an aspect, the technology relates to optimizing firmware updates. The system includes at least one processor, and memory coupled to the processor, the memory consisting of computer executable instructions that are executed by the system to perform operations. The operations include: receiving, in a volatile storage, an update to a stored firmware in a non-volatile storage and the update contains one or more portions, comparing a portion of the one or more portions of the update to a corresponding portion of the stored firmware to identify differences, when the portion of the update is different from the corresponding portion of the stored firmware, computing a parity value based on the portion of the update and the corresponding portion of the stored firmware, storing the parity value in the non-volatile storage and the parity value is associated with the portion of the update, and copying the update as the stored firmware.

In an example, the operations further includes: loading the processor with the update to the stored firmware. In another example, the operations further includes: determining a corruption portion in the update, and recovering the update. In still another example, determining a corruption in the update further includes identifying instability of the processor loaded with the update. In yet another example, determining a corruption in the update further includes identifying errors when executing the update. In still yet another example, recovering the update further includes: for each portion of the update, determining a revised portion of the update using the portion of the update and the parity value associated with the portion of the update, and replacing the corrupted portion with the revised portion of the update. In still yet another example, the revised portion matches the corresponding portion of the stored firmware.

In an example, comparing a portion of the update to the corresponding portion of the stored firmware to identify differences further includes generating an entry in a difference list for the portion of the update. In another example, generating an entry in a difference list for the portion of the update further includes: storing a zero in the difference list when a portion of the update matches the corresponding portion of the stored firmware, and storing a one in the difference list when the portion of the update does not match the corresponding portion of the stored firmware. In still another example, generating an entry in a difference list for the portion of the update further includes: performing a logical XOR operation between the portion of the update and the corresponding portion of the stored firmware.

In an example, computing a parity value based on the portion of the update and the corresponding portion of the stored firmware further includes performing a bitwise XOR operation between each bit of the portion of the update and a corresponding bit of the corresponding portion of the stored firmware.

In an example, the volatile storage is a Random Access Memory (RAM) and the non-volatile storage is a NOR storage.

In another aspect, the technology related to a computer-implemented method for optimizing firmware updates. The method includes: receiving an updated firmware in a volatile storage, comparing the updated firmware to a stored firmware in a non-volatile storage to identify differences in code of the updated firmware and the stored firmware and the updated firmware is compared to the stored firmware in portions to determine a difference list, generating parity values for one or more portions of the updated firmware that are different from corresponding portions of the stored firmware, and copying the updated firmware as the stored firmware.

In an example, copying the updated firmware as the stored firmware further includes copying the updated firmware to a partition in the non-volatile storage. In another example, copying the updated firmware to a partition in the non-volatile storage further includes copying only portions of the updated firmware that are different from the corresponding portions of the stored firmware to replace the corresponding portions of the stored firmware.

In an example, comparing the updated firmware to a stored firmware in a non-volatile storage to identify differences in code of the updated firmware and the stored firmware further includes: copying a portion of the updated firmware to a first buffer in the non-volatile storage, copying a corresponding portion of the stored firmware to a second buffer in the non-volatile storage, comparing contents of the first buffer and the second buffer to identify differences, and generating an entry in a difference list based on a result of identified differences between the contents of the first buffer and the second buffer.

In an example, generating parity values for portions of the updated firmware that are different from corresponding portions of the stored firmware further includes: generating the parity values in a first buffer in the non-volatile storage, and copying the parity values and associations to the portions of the updated firmware and the corresponding portions of the stored firmware into a partition of the non-volatile storage.

In an example, the parity values and the difference list are in separate partitions of the non-volatile storage.

In an example, a copy of the stored firmware is present in a partition of the non-volatile storage.

In still another aspect, the technology relates to optimizing firmware updates. The firmware update system includes at least one processor, and memory coupled to the processor, the memory consisting of computer executable instructions that are executed by the system to perform operations. The operations include: identifying differences between each portion of an update to a firmware to a corresponding portion of the firmware, wherein each portion of the update and the corresponding portion of the firmware are copied to page buffers for comparison, storing a result of the differences in a difference list partition of a storage, computing parity values based on the portion of the update and the corresponding portion of the firmware when the corresponding portions are different, storing the parity values in a parity partition of the storage, and loading the processor using the update, wherein the update to the firmware replaces the firmware.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

Furthermore, those skilled in the art will recognize that boundaries between the functionality of the above-described operations are merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

Although the disclosure provides specific examples, various modifications and changes can be made without departing from the scope of the disclosure as set forth in the claims below. Accordingly, the specification and figures are to be regarded in an illustrative rather than a restrictive sense, and all such modifications are intended to be included within the scope of the present disclosure. Any benefits, advantages, or solutions to problems that are described herein with regard to a specific example are not intended to be construed as a critical, required, or essential feature or element of any or all the claims.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to containing only one such element, even when the same claim includes the introductory phrases “one or more” or “at least one” and indefinite articles such as “a” or “an.” The same holds true for the use of definite articles.

Unless stated otherwise, terms such as “first” and “second” are used to arbitrarily distinguish between the elements such terms describe. Thus, these terms are not necessarily intended to indicate temporal or other prioritization of such elements.

What is claimed is:

1. A firmware update system comprising:
a processor; and
memory comprising computer executable instructions that, when executed, perform operations comprising:
receiving, in a volatile storage, an update to a stored firmware in a non-volatile storage, wherein the update contains one or more portions;
comparing a portion of the one or more portions of the update to a corresponding portion of the stored firmware to identify differences;
when the portion of the update is different from the corresponding portion of the stored firmware, computing a parity value based on the portion of the update and the corresponding portion of the stored firmware;
storing the parity value in the non-volatile storage, wherein the parity value is associated with the portion of the update; and
copying the update as the stored firmware.

2. The firmware update system of claim 1, wherein the operations further comprise:
loading the processor with the update to the stored firmware.

3. The firmware update system of claim 2, wherein the operations further comprise:
determining a corruption portion in the update; and
recovering the update.

4. The firmware update system of claim 3, wherein determining a corruption in the update further comprises:
identifying instability of the processor loaded with the update.

5. The firmware update system of claim 3, wherein determining a corruption in the update further comprises:
identifying errors when executing the update.

6. The firmware update system of claim 3, wherein recovering the update further comprises:
for each portion of the update, determining a revised portion of the update using the portion of the update and the parity value associated with the portion of the update; and
replacing the corrupted portion with the revised portion of the update.

7. The firmware update system of claim 6, wherein the revised portion matches the corresponding portion of the stored firmware.

8. The firmware update system of claim 1, wherein comparing a portion of the update to the corresponding portion of the stored firmware to identify differences further comprises:
generating an entry in a difference list for the portion of the update.

9. The firmware update system of claim 8, wherein generating an entry in a difference list for the portion of the update further comprises:
storing a zero in the difference list when a portion of the update matches the corresponding portion of the stored firmware; and
storing a one in the difference list when the portion of the update does not match the corresponding portion of the stored firmware.

10. The firmware update system of claim 8, wherein generating an entry in a difference list for the portion of the update further comprises:
performing a logical XOR operation between the portion of the update and the corresponding portion of the stored firmware.

11. The firmware update system of claim 1, wherein computing a parity value based on the portion of the update and the corresponding portion of the stored firmware further comprises:
performing a bitwise XOR operation between each bit of the portion of the update and a corresponding bit of the corresponding portion of the stored firmware.

12. The firmware update system of claim 1, wherein the volatile storage is a Random Access Memory (RAM) and the non-volatile storage is a NOR storage.

13. A computer implemented method for optimizing firmware updates, the method comprises:
receiving an updated firmware in a volatile storage;
comparing the updated firmware to a stored firmware in a non-volatile storage to identify differences in code of the updated firmware and the stored firmware, wherein the updated firmware is compared to the stored firmware in portions to determine a difference list;
generating parity values for one or more portions of the updated firmware that are different from corresponding portions of the stored firmware; and
copying the updated firmware as the stored firmware.

14. The method of claim 13, wherein copying the updated firmware as the stored firmware further comprises:
copying the updated firmware to a partition in the non-volatile storage.

15. The method of claim 14, wherein copying the updated firmware to a partition in the non-volatile storage further comprises:
copying only portions of the updated firmware that are different from the corresponding portions of the stored firmware to replace the corresponding portions of the stored firmware.

16. The method of claim 13, wherein comparing the updated firmware to a stored firmware in a non-volatile storage to identify differences in code of the updated firmware and the stored firmware further comprises:
copying a portion of the updated firmware to a first buffer in the non-volatile storage;
copying a corresponding portion of the stored firmware to a second buffer in the non- volatile storage;
comparing contents of the first buffer and the second buffer to identify differences; and
generating an entry in a difference list based on a result of identified differences between the contents of the first buffer and the second buffer.

17. The method of claim 13, wherein generating parity values for portions of the updated firmware that are different from corresponding portions of the stored firmware further comprises:
generating the parity values in a first buffer in the non-volatile storage; and
copying the parity values and associations to the portions of the updated firmware and the corresponding portions of the stored firmware into a partition of the non-volatile storage.

18. The method of claim 13, wherein the parity values and the difference list are in separate partitions of the non-volatile storage.

19. The method of claim 13, wherein a copy of the stored firmware is present in a partition of the non-volatile storage.

20. A firmware update system comprising:
a processor; and
memory comprising computer executable instructions that, when executed, perform operations comprising:
identifying differences between each portion of an update to a firmware to a corresponding portion of the firmware, wherein each portion of the update and the corresponding portion of the firmware are copied to page buffers for comparison;
storing a result of the differences in a difference list partition of a storage;
computing parity values based on the portion of the update and the corresponding portion of the firmware when the corresponding portions are different;
storing the parity values in a parity partition of the storage; and
loading the processor using the update, wherein the update to the firmware replaces the firmware.
